(19) United States
(12) Patent Application Publication
(10) Pub. No.: US 2025/0061098 A1
(43) Pub. Date: Feb. 20, 2025

(54) DATA MIGRATION SYSTEM, METHOD AND APPARATUS FOR INTERNET-OF-THINGS DEVICE, AND STORAGE MEDIUM

(71) Applicant: E SURFING IOT CO., LTD., Guangzhou, Guangdong (CN)

(72) Inventors: Yang CHEN, Guangzhou, Guangdong (CN); Zhuorui LAN, Guangzhou, Guangdong (CN); Jiayang DONG, Guangzhou, Guangdong (CN); Jintao SUN, Guangzhou, Guangdong (CN); Yuan LIU, Guangzhou, Guangdong (CN); Le SONG, Guangzhou, Guangdong (CN)

(21) Appl. No.: 18/724,861

(22) PCT Filed: Dec. 20, 2022
(86) PCT No.: PCT/CN2022/140392

§ 371 Date: Aug. 8, 2024

(30) Foreign Application Priority Data
Dec. 30, 2021 (CN) 202111652214.3

(51) Int. Cl. G06F 16/21; G06F 3/06; H04L 67/1097

(52) U.S. Cl. CPC G06F 16/214; G06F 3/0647; G06F 3/067; H04L 67/1097; G06F 3/0602

(57) ABSTRACT

A data migration system, method and apparatus for an Internet-of-Things device, and a storage medium are disclosed, which relates to the technical field of Internet of Things communications. The data migration system for an Internet of Things device includes a gateway platform and an Internet of Things platform. The Internet of Things platform includes a plurality of server clusters; and a virtual private channel is established between the gateway platform and each of the server clusters of the Internet of Things platform for communication. The gateway platform is configured for receiving data of the Internet of Things device, determining a user identifier of the Internet of Things device according to the data, determining a virtual private channel for transmitting the data according to the user identifier, and sending the data through the virtual private channel. The user identifier is preset in the gateway platform.

### TECHNICAL FIELD

The present disclosure relates to the technical field of Internet of Things communications, in particular to a data migration system, method and apparatus for an Internet of Things device, and a storage medium.

### BACKGROUND

In the field of mobile cellular Internet of Things communications, an Internet of Things platform provides unified management for Internet of Things devices and data collection functions. The Internet of Things device is accessed to a server cluster of the Internet of Things platform through a mobile communication network and then through a backbone bearer network. Generally, the Internet of Things platform needs to configure a public IP address of the server cluster to the Internet of Things device, and the Internet of Things device sends data to the server cluster accessed to the Internet of Things platform based on the configured IP address.

At present, with the increasing number of the Internet of Things devices, the business processing pressure on the Internet of Things platform is increasing gradually, necessitating the addition of IP addresses to increase the server clusters for load distribution. However, given the wide geographic distribution and large number of Internet of Things devices, reconfiguring the destination IP addresses on-site or remotely to migrate the data of the Internet of Things devices to a new server cluster would incur significant labor and time costs.

### SUMMARY

The present disclosure aims to solve at least one of the technical problems in the related art. Therefore, the present disclosure provides a data migration system, method and apparatus for an Internet of Things device, and a storage medium.

In one aspect, the embodiments of the present disclosure provide a data migration system for an Internet of Things device, including a gateway platform and an Internet of Things platform, wherein the Internet of Things platform includes a plurality of server clusters;
a virtual private channel is established between the gateway platform and each of the server clusters of the Internet of Things platform for communication; and
the gateway platform is configured for receiving data of the Internet of Things device, determining a user identifier of the Internet of Things device according to the data, determining a virtual private channel for transmitting the data according to the user identifier, and sending the data through the virtual private channel, wherein the user identifier is preset in the gateway platform.

According to some embodiments of the present disclosure, the gateway platform includes a device access authentication module for:
acquiring the device identifier of the Internet of Things device;
generating a user identifier and a first IP address for the Internet of Things device according to the device identifier;
sending the first IP address to the Internet of Things device; and
binding the device identifier and the user identifier to form a first relational mapping table.

According to some embodiments of the present disclosure, the gateway platform further includes a data packet forwarding module for:
analyzing the data to obtain the device identifier of the Internet of Things device;
querying the first relational mapping table according to the device identifier to obtain the user identifier; and
querying a second relational mapping table according to the user identifier to obtain the virtual private channel for transmitting the data; and sending the data through the virtual private channel.

According to some embodiments of the present disclosure, the server cluster is configured for:
receiving the data from the virtual private channel;
analyzing a second IP address in the data; and
determining a destination server according to the second IP address.

According to some embodiments of the present disclosure, the gateway platform further includes a configuration module for:
acquiring a configuration instruction;
in response to the configuration instruction, analyzing the configuration instruction to obtain the user identifier and a server cluster number;
determining the virtual private channel according to the server cluster number; and
binding the virtual private channel and the user identifier in the configuration instruction to form the second relational mapping table.

In another aspect, the embodiments of the present disclosure further provide a data migration method for an Internet of Things device, applied to the gateway platform in the data migration system for an Internet of Things device mentioned above, and comprising:
receiving the data of the Internet of Things device;
determining the user identifier of the Internet of Things device according to the data;
determining the virtual private channel for transmitting the data according to the user identifier; and
sending the data through the virtual private channel.

According to some embodiments of the present disclosure, the data migration method for an Internet of Things device further includes:
acquiring the device identifier of the Internet of Things device;
generating a user identifier and a first IP address for the Internet of Things device according to the device identifier;
sending the first IP address to the Internet of Things device; and
binding the device identifier and the user identifier to form a first relational mapping table.

According to some embodiments of the present disclosure, determining the user identifier of the Internet of Things device according to the data includes:
analyzing the data to obtain the device identifier of the Internet of Things device; and
querying the first relational mapping table according to the device identifier to obtain the user identifier, wherein the user identifier is preset in the gateway platform; and
determining the virtual private channel for transmitting the data according to the user identifier includes:
   querying a second relational mapping table according to the user identifier to obtain the virtual private channel for transmitting the data.

In another aspect, the embodiments of the present disclosure further provide a data migration apparatus for an Internet of Things device, including:
at least one processor; and
at least one memory configured for storing at least one program;
wherein the at least one program, when executed by the at least one processor, causes the at least one processor to implement the data migration method for an Internet of Things device mentioned above.

In another aspect, the embodiments of the present disclosure further provide a computer-readable storage medium storing a processor-executable program which, when executed by a computer, causes the computer to implement the data migration method for an Internet of Things device mentioned above.

The technical solutions of the present disclosure at least have one of the following advantages or beneficial effects. When the Internet of Things device transmits data to the server cluster of the Internet of Things platform, firstly, the gateway platform receives the data of the Internet of Things device, determines the user identifier of the Internet of Things device preset in the gateway platform according to the data, and determines the virtual private channel for transmitting the data based on the user identifier. Since each virtual private channel corresponds to one server cluster, the data of the Internet of Things device can be migrated to the corresponding server cluster after the virtual private channel is determined. By establishing the virtual private channel between the gateway platform and each server cluster of the Internet of Things platform, the gateway platform addresses and forwards the data according to the IP address in the data, and the virtual private channel is determined according to the user identifier of the Internet of Things device, so that the data can be transmitted to the server cluster corresponding to the virtual private channel. Therefore, the migration of the data of the Internet of Things device can be realized only by changing the user identifier preset in the gateway platform without changing the configuration of the Internet of Things device, which saves the data migration cost for the Internet of Things device.

### BRIEF DESCRIPTION OF THE DRAWINGS

FIG. 1 is a schematic diagram of a data migration system for an Internet of Things device provided by an embodiment of the present disclosure;

FIG. 2 is a schematic diagram of a data migration system for an Internet of Things device provided by another embodiment of the present disclosure;

FIG. 3 is a flow chart of a data migration method for an Internet of Things device provided by an embodiment of the present disclosure;

FIG. 4 is a schematic diagram of an application framework of the data migration method for an Internet of Things device provided by the embodiment of the present disclosure; and

FIG. 5 is a schematic diagram of a data migration apparatus for an Internet of Things device provided by an embodiment of the present disclosure.

### DETAILED DESCRIPTION

The embodiments of the present disclosure will be described in detail hereinafter. Examples of the embodiments are shown in the drawings. The same or similar reference numerals throughout the drawings denote the same or similar elements or elements having the same or similar functions. The embodiments described below by reference to the accompanying drawings are exemplary and are intended only to explain the present disclosure and are not to be construed as limiting the present disclosure.

In the description of the present disclosure, it should be understood that the orientation or position relation related to the orientation description, such as the orientation or position relation indicated by the terms such as upper, lower, front, rear, left, right, etc., is based on the orientation or position relation shown in the drawings, which is only configured for convenience of description of the present disclosure and simplification of description instead of indicating or implying that the indicated device or element must have a specific orientation, and be constructed and operated in a specific orientation, and thus shall not be understood as a limitation to the present disclosure.

In the description of the present disclosure, if the terms such as first and second are described, they are configured for the purpose of distinguishing the technical features only, and cannot be understood as indicating or implying relative importance, or implicitly indicating the number of technical features indicated thereby, or implicitly indicating the order of technical features indicated thereby.

Before the embodiments of the present disclosure are further explained in detail, the nouns and terms involved in the embodiments of the present disclosure are explained, and the nouns and terms involved in the embodiments of the present disclosure are applicable to the following explanations.

Home Subscriber Server (HSS): an important component of a control layer in an IP Multimedia Subsystem (IMS). The HSS supports a primary user database of an IMS network entity for handling/calling sessions. The HSS contains a user profile, performs identity authentication and authorization of the user, and may provide information about a physical location of the user. The HS S is similar to GSMHomeLocationregister. Entities communicating with the HSS include an application server and a call session control function server.

Mobility Management Entity (MME): a key control node of a 3GPP protocol LTE access network, which is responsible for positioning and paging processes of User Equipment (UE) in an idle mode, including relay. Simply speaking, the MME is responsible for signaling processing. The MME involves activation/deactivation process of a bearer, and selects one Serving GateWay (SGW) for the UE when the UE is initialized and connected. The MME authenticates one user by interacting with the HSS, and assigns one temporary ID to the user.

Serving GateWay (SGW): an important network element in a mobile communication core network. In a traditional network, a Serving GPRS Support Node (SGSN) is not only responsible for functions related to signaling planes such as mobility management and user access control, but also responsible for forwarding user data. Based on the idea of control and bearer separation, functions of the SGSN are split in the mobile communication core network, that is, the signaling plane function is taken over by the MME network element, while the user plane function of user data forwarding is taken over by the SGW network element.

PDN GateWay (PGW): as a border gateway of the mobile communication core network, it provides functions such as user session management and bearer control, data forwarding, IP address allocation and access for non-3GPP users. The PGW is an anchor point for 3GPP access and non-3GPP access with a public data network PDN. The 3GPP access refers to wireless access technology from a 3GPP standard family, while the non-3GPP access refers to wireless access technology excluding the 3GPP standard family.

Customer Edge (CE): a client router to which a service provider is connected. The CE router provides service access for the user by connecting one or more PE routers.

Virtual Private Network (VPN): remote access technology, which uses data encapsulation and encryption technologies to set up a private network on a public network, thus forming a virtual private channel on the public network. A VPN gateway realizes remote access by encrypting a data packet and translating a destination address of the data packet. The VPN can be realized in many ways, such as server, hardware and software.

Each server cluster on an Internet of Things platform provides a public IP address to the outside, and intranet IP addresses are employed inside the server cluster. The traditional Internet of Things device sends data to the Internet of Things platform through the following method: the Internet of Things device is configured with a destination IP address of a destination server, and the Internet of Things device encapsulates a data packet based on the destination IP address and sends the data packet to a gateway platform for forwarding. The gateway platform forwards the data to a corresponding server cluster according to an IP address addressing method, and the server cluster forwards the data to the destination server in the server cluster based on the destination IP address in the data. Because the IP address addressing method is used to forward the data in the gateway platform, the intranet IP addresses in different server clusters cannot be the same, otherwise routing conflicts will occur. In order to migrate the data of the Internet of Things device to other server clusters, the destination IP address configured in the Internet of Things device has to be changed.

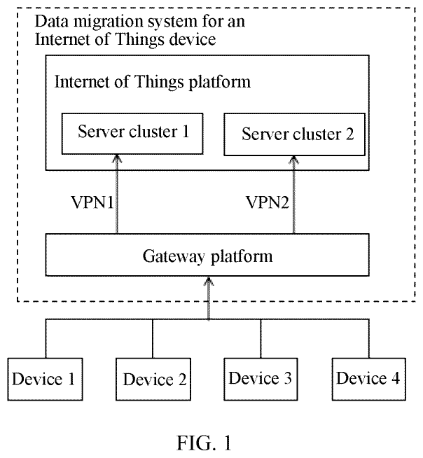

Based on this, the embodiments of the present disclosure provide a data migration system for an Internet of Things device. Referring to FIG. 1, the data migration system for an Internet of Things device includes a gateway platform and an Internet of Things platform, wherein the Internet of Things platform includes a plurality of server clusters. A virtual private channel is established between the gateway platform and each of the server clusters of the Internet of Things platform for communication.

The gateway platform is configured for receiving data of the Internet of Things device, determining a user identifier of the Internet of Things device according to the data, determining a virtual private channel for transmitting the data according to the user identifier, and sending the data through the virtual private channel, wherein the user identifier is preset in the gateway platform.

Specifically, taking the data migration system for an Internet of Things device shown in FIG. 1 for example, the data migration system for an Internet of Things device includes the gateway platform and the Internet of Things platform. The Internet of Things platform includes a server cluster 1 and a server cluster 2. Based on VPN technology, a virtual private channel is established between the gateway platform and the server cluster 1, which is denoted as VPN1, and a virtual private channel is also established between the gateway platform and the server cluster 2, which is denoted as VPN2. The Internet of Things devices including a device 1, a device 2, a device 3 and a device 4 are accessed to the gateway platform. When the gateway platform receives the data of any one of the Internet of Things devices, determines a user identifier of the Internet of Things device preset in the gateway platform according to the data received, and then determines a virtual private channel for transmitting the data according to the user identifier. For example, the virtual private channel corresponding to a user identifier “1” is the VPN1, the virtual private channel corresponding to a user identifier “2” is the VPN2, the user identifiers of the device 1 and the device 2 in the gateway platform are “1” and the user identifiers of the device 3 and the device 4 in the gateway platform are “2”. Therefore, the data of the device 1 and the device 2 are transmitted to the server cluster 1 through the VPN1, and the data of the device 3 and the device 4 are transmitted to the server cluster 2 through the VPN2. Because different virtual private channels are established between the gateway platform and different server clusters, and the virtual private channels can realize network isolation and avoid routing conflicts, destination IP addresses of data transmitted in different virtual private channels can be the same. For example, the destination IP addresses configured in the device 1 and the device 3 are the same, but because the preset user identifiers of the device 1 and the device 3 in the gateway platform are different, addressing in different server clusters can be realized through different virtual private channels. If it is necessary to migrate the data of the device 1 to the server cluster 2, as long as the user identifier of the device 1 in the gateway platform is changed to “2”, the data of the device 1 can be transmitted to the server cluster 2 through the VPN2 without changing the destination IP address configured in the device 1.

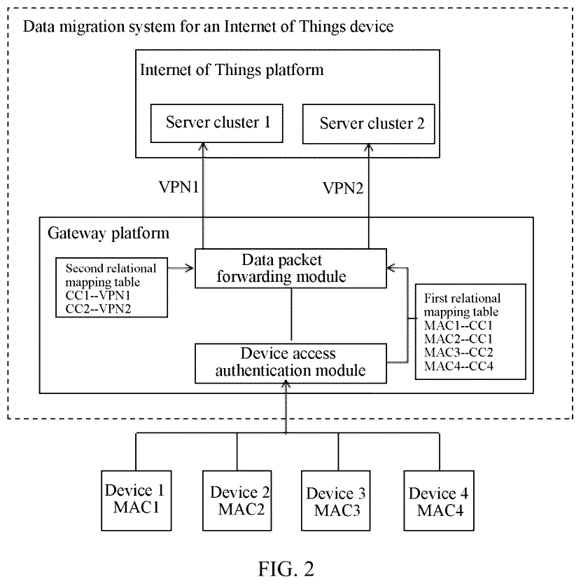

According to some specific embodiments of the present disclosure, referring to FIG. 2, the gateway platform includes a device access authentication module, and the device access authentication module is configured for:
acquiring a device identifier of the Internet of Things device;
generating a user identifier and a first IP address for the Internet of Things device according to the device identifier;
sending the first IP address to the Internet of Things device; and
binding the device identifier and the user identifier to form a first relational mapping table.

Specifically, the Internet of Things device initiates a network access request to the device access authentication module. The device access authentication module takes an MAC address of the Internet of Things device as the device identifier, assigns a Charging Character (CC) value to the MAC address of the Internet of Things device as the user identifier, and then binds the MAC address and the CC value to form the first relational mapping table. In addition, the device access authentication module also assigns one first IP address as a source IP address to the Internet of Things device after the Internet of Things device initiates an authentication request, and sends the assigned first IP address to the Internet of Things device, and the network access request of the Internet of Things device is successful.

According to some embodiments of the present disclosure, referring to FIG. 2, the gateway platform further includes a data packet forwarding module, and the data packet forwarding module is configured for:
analyzing the data to obtain the device identifier of the Internet of Things device;
querying the first relational mapping table according to the device identifier to obtain the user identifier;
querying a second relational mapping table according to the user identifier to obtain the virtual private channel for transmitting the data; and
sending the data through the virtual private channel.

Specifically, the Internet of Things device uses the first IP address as the source IP address to send the data to the server cluster in the Internet of Things platform through the gateway platform. The data packet forwarding module in the gateway platform analyzes the data of the Internet of Things device to get the MAC address of the Internet of Things device, queries the first relational mapping table in the device access authentication module according to the MAC address to get the corresponding CC value, then queries the second relational mapping table according to the CC value to determine the corresponding virtual private channel, and then sends the data to the corresponding server cluster through the virtual private channel.

According to some specific embodiments of the present disclosure, the server cluster is configured for:
receiving the data from the virtual private channel;
analyzing a second IP address in the data; and
determining a destination server according to the second IP address.

Specifically, the server cluster is configured with a firewall device, in which only the data of the corresponding virtual private channel is received by decrypting to identify the data packet, and the data of other virtual private channels are isolated. The data are analyzed to obtain the second IP address of the data in the service server cluster, which is the destination IP address of the data, and then the destination server or the next-level destination server cluster is determined according to the second IP address and the data are forwarded thereto.

According to some specific embodiments of the present disclosure, the gateway platform further includes a configuration module configured for:
acquiring a configuration instruction;
in response to the configuration instruction, analyzing the configuration instruction to obtain the user identifier and a server cluster number;
determining the virtual private channel according to the server cluster number; and
binding the virtual private channel and the user identifier in the configuration instruction to form the second relational mapping table.

Specifically, the configuration module acquires the configuration instruction input by the user, and the configuration instruction includes the user identifier and the server cluster number. In the configuration module, in response to the configuration instruction, the configuration instruction is analyzed to obtain the user identifier and the server cluster number, and then the corresponding virtual private channel is determined according to the server cluster number, and the virtual private channel and the user identifier in the configuration instruction are bound to form the second relational mapping table, thus migrating the data of the Internet of Things device in batches. In this embodiment, the correspondence between the user identifier and the virtual private channel in the gateway platform can be changed through the configuration instruction, for example, the virtual private channel corresponding to the user identifier “2” is modified to the VPN1, and the data of all the Internet of Things devices with the user identifier “2” can be migrated to the server cluster 1 in batches.

In some embodiments, the configuration instruction input by the user may also include the user identifier and the device identifier. In the configuration module, in response to the configuration instruction, the configuration instruction is analyzed to obtain the user identifier and the device identifier, and then the user identifier and the device identifier in the configuration instruction are bound to form the second relational mapping table, thus migrating the data of a certain Internet of Things device. In this embodiment, the correspondence between the user identifier and the device identifier in the gateway platform can be changed through the configuration instruction, for example, the user identifier corresponding to the device identifier “MAC1” is modified from “1” to “2”, and the data of the Internet of Things device with the user identifier “MAC1” can be migrated from the server cluster 1 to the server cluster 2.

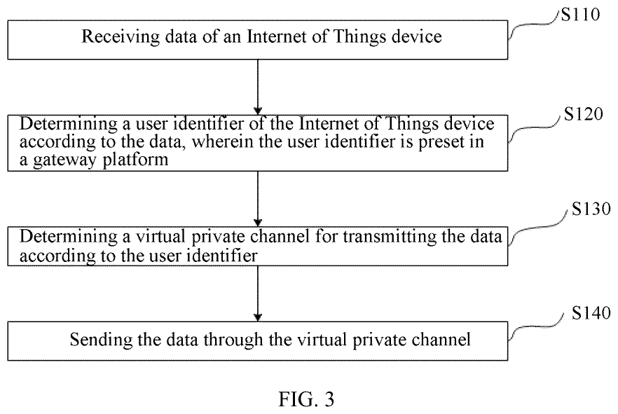

The embodiments of the present disclosure provide a data migration method for an Internet of Things device, applied to the gateway platform of the data migration system for an Internet of Things device according to the above embodiments. Referring to FIG. 3, the data migration method for an Internet of Things device according to the embodiments of the present disclosure includes, but is not limited to step S110, step S120, step S130 and step S140.

Step S110: receiving the data of the Internet of Things device;
Step S120: determining the user identifier of the Internet of Things device according to the data, wherein the user identifier is preset in the gateway platform;
Step S130: determining the virtual private channel for transmitting the data according to the user identifier; and
Step S140: sending the data through the virtual private channel.

In this embodiment, the gateway platform receives the data of the Internet of Things device, determines the user identifier of the Internet of Things device preset in the gateway platform according to the data, and determines the virtual private channel for transmitting the data based on the user identifier. Since each virtual private channel corresponds to one server cluster, the data of the Internet of Things device can be migrated to the corresponding server cluster after the virtual private channel is determined. By establishing the virtual private channel between the gateway platform and each server cluster of the Internet of Things platform, the gateway platform addresses and forwards the data according to the IP address in the data, and the virtual private channel is determined according to the user identifier of the Internet of Things device, so that the data can be transmitted to the server cluster corresponding to the virtual private channel. Therefore, the migration of the data of the Internet of Things device can be realized only by changing the user identifier preset in the gateway platform without changing the configuration of the Internet of Things device, which saves the data migration cost for the Internet of Things device.

According to some specific embodiments of the present disclosure, the data migration method for an Internet of Things device further includes, but is not limited to the following steps:
acquiring a device identifier of the Internet of Things device;
generating a user identifier and a first IP address for the Internet of Things device according to the device identifier;
sending the first IP address to the Internet of Things device; and
binding the device identifier and the user identifier to form a first relational mapping table.

In this embodiment, network access attachment can be realized for the Internet of Things device, wherein the network access attachment includes allocating the first IP address for the Internet of Things device, that is, a source IP address in a data packet uploaded by the Internet of Things device, and the network access attachment further includes presetting the user identifier for the Internet of Things device.

According to some specific embodiments of the present disclosure, the step S120 includes, but is not limited to the following steps:
analyzing the data to obtain the device identifier of the Internet of Things device; and
querying the first relational mapping table according to the device identifier to obtain the user identifier; and
the step S130 includes, but is not limited to the following step:
querying a second relational mapping table according to the user identifier to obtain the virtual private channel for transmitting the data.

In this embodiment, based on the device identifier in the data of the Internet of Things device, the virtual private channel for transmitting the data is determined by querying the first relational mapping table and the second relational mapping table, so as to send the data to the corresponding server cluster through the corresponding virtual private channel.

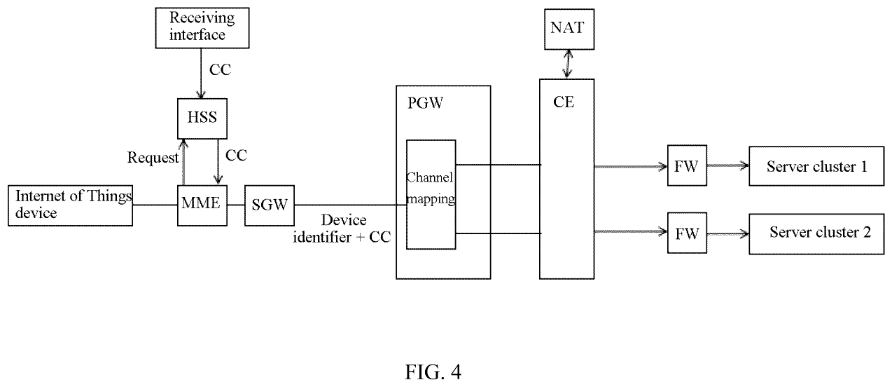

Referring to FIG. 4, the data migration method for an Internet of Things device according to the embodiments of the present disclosure is explained hereinafter by taking the gateway platform being a 4G core network and the user identifier being a CC value as an example.

The 4G core network includes an MME network element, an HSS network element, a SGW network element, a PGW network element and a CE network element. An Internet of Things device of a certain user initiates a network access request to the MME network element, the MME network element sends the network access request to the HSS network element, and the HSS network element acquires a CC value from a receiving interface and returns the CC value to the MME network element. The MME network element sends the device identifier and the CC value of the Internet of Things device to the SGW network element for storage. When the Internet of Things device uploads the data to the server cluster of the Internet of Things platform, the data of the Internet of Things device are mapped in the SGW network element to obtain the user identifier, and the virtual private channel is determined in the PGW network element according to the user identifier. The Network Address Translation (NAT) technology is adopted in the CE network element to send the data to the corresponding virtual private channel, so as to send the data to the corresponding server cluster. A Fire Wall (FW) on the server cluster realizes data receiving in the corresponding virtual private channel.

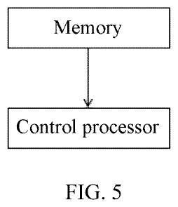

Referring to FIG. 5, FIG. 5 is a schematic diagram of a data migration apparatus for an Internet of Things device provided by an embodiment of the present disclosure. The data migration apparatus for the Internet of Things device of the embodiment of the present disclosure includes one or more control processors and memories, and one control processor and one memory are taken as an example in FIG. 5.

The control processor and the memory may be connected by a bus or in other ways, and connecting by bus is taken as an example in FIG. 5.

As a non-transient computer-readable storage medium, the memory may be used to store non-transient software and non-transient computer-executable programs. In addition, the memory may include a high-speed random access memory, and may also include a non-transient memory, such as at least one disk memory device, a flash memory device, or other non-transient solid storage devices. In some embodiments, the memory optionally includes a memory remotely disposed with respect to the control processor, which may be connected to the data migration apparatus for the Internet of Things device through a network. Examples of the networks above include, but are not limited to, the Internet, intranet, local area networks, mobile communication networks, and combinations thereof.

Those of ordinary skills in the art can understand that the apparatus structure shown in FIG. 5 does not constitute a limitation to the data migration apparatus for the Internet of Things device, and may include more or less components than the illustrated components, or combine some components, or have different component arrangements.

Non-transient software programs and instructions required to realize the data migration method for an Internet of Things device applied to the data migration apparatus for the Internet of Things device in the foregoing embodiments are stored in the memory, which, when executed by the control processor, cause the processor to execute the data migration method for an Internet of Things device applied in the data migration apparatus for the Internet of Things device described above.

Moreover, an embodiment of the present application further provides a computer-readable storage medium that stores a computer-executable instruction, which, when operated by one or more control processors, causes the one or more control processors to execute the data migration method for an Internet of Things device described in the above-mentioned method embodiments.

Those of ordinary skills in the art will appreciate that all or some of the steps in the methods and the systems disclosed above may be implemented as software, firmware, hardware, and suitable combinations thereof. Some physical components or all of the physical components may be implemented as software executed by a processor, such as a central processing unit, a digital signal processor or a microprocessor, or implemented as hardware, or implemented as an integrated circuit, such as an application specific integrated circuit. Such software may be distributed on a computer-readable medium, and the computer-readable medium may include a computer storage medium (or non-transitory medium) and a communication medium (or transitory medium). As well known to those of ordinary skills in the art, the term computer storage medium includes volatile and non-volatile, removable and non-removable media implemented in any method or technology for storing information (such as computer-readable instruction, data structure, programming module or other data). The computer storage medium includes, but is not limited to, RAM, ROM, EEPROM, flash memory or other memory technology, CD-ROM, digital versatile disc (DVD) or other optical disc memory, magnetic cassette, magnetic tape, magnetic disk memory or other magnetic memory device, or may be any other medium that can be used to store the desired information and can be accessed by a computer. Moreover, it is well known to those of ordinary skills in the art that the communication medium typically includes computer-readable instructions, data structures, program modules, or other data in a modulated data signal, such as a carrier wave or other transmission mechanism, and may include any information delivery medium.

The embodiments of the present disclosure are described in detail with reference to the drawings above, but the present disclosure is not limited to the above embodiments, and various changes may also be made within the knowledge scope of those of ordinary skills in the art without departing from the purpose of the present disclosure.

1. A data migration system for an Internet of Things device, comprising a gateway platform and an Internet of Things platform, wherein the Internet of Things platform comprises a plurality of server clusters;
a virtual private channel is established between the gateway platform and each of the server clusters of the Internet of Things platform for communication; and
the gateway platform is configured for receiving data of the Internet of Things device, determining a user identifier of the Internet of Things device according to the data, determining a virtual private channel for transmitting the data according to the user identifier, and sending the data through the virtual private channel, wherein the user identifier is preset in the gateway platform.

2. The data migration system for an Internet of Things device according to claim 1, wherein the gateway platform comprises a device access authentication module for:
acquiring a device identifier of the Internet of Things device;
generating a user identifier and a first IP address for the Internet of Things device according to the device identifier;

3. The data migration system for an Internet of Things device according to claim 2, wherein the gateway platform further comprises a data packet forwarding module for:
analyzing the data to obtain the device identifier of the Internet of Things device;
querying the first relational mapping table according to the device identifier to obtain the user identifier;
querying a second relational mapping table according to the user identifier to obtain the virtual private channel for transmitting the data; and
sending the data through the virtual private channel.

4. The data migration system for an Internet of Things device according to claim 3, wherein each of the server clusters is configured for:
receiving the data from the virtual private channel;
analyzing a second IP address in the data; and
determining a destination server according to the second IP address.

5. The data migration system for an Internet of Things device according to claim 3, wherein the gateway platform further comprises a configuration module for:
acquiring a configuration instruction;
in response to the configuration instruction, analyzing the configuration instruction to obtain the user identifier and a server cluster number;
determining the virtual private channel according to the server cluster number; and
binding the virtual private channel and the user identifier in the configuration instruction to form the second relational mapping table.

6. A data migration method for an Internet of Things device, applied to the gateway platform of the data migration system for an Internet of Things device according to claim 1, and comprising:
receiving the data of the Internet of Things device;
determining the user identifier of the Internet of Things device according to the data, wherein the user identifier is preset in the gateway platform;
determining the virtual private channel for transmitting the data according to the user identifier; and
sending the data through the virtual private channel.

7. The data migration method for an Internet of Things device according to claim 6, further comprising:
acquiring a device identifier of the Internet of Things device;
generating a user identifier and a first IP address for the Internet of Things device according to the device identifier;
sending the first IP address to the Internet of Things device; and
binding the device identifier and the user identifier to form a first relational mapping table.

8. The data migration method for an Internet of Things device according to claim 7, wherein,
determining the user identifier of the Internet of Things device according to the data comprises:
analyzing the data to obtain the device identifier of the Internet of Things device; and
querying the first relational mapping table according to the device identifier to obtain the user identifier; and
determining the virtual private channel for transmitting the data according to the user identifier comprises:
querying a second relational mapping table according to the user identifier to obtain the virtual private channel for transmitting the data.

9. A data migration apparatus for an Internet of Things device, comprising:
at least one processor; and
at least one memory configured for storing at least one program;
wherein the at least one program, when executed by the at least one processor, causes the at least one processor to implement the data migration method for an Internet of Things device according to claim 6.

10. A non-transitory computer-readable storage medium storing a processor-executable program which, when executed by a processor, causes the processor to implement the data migration method for an Internet of Things device according to claim 6.
